(19) United States
(12) Patent Application Publication
(10) Pub. No.: US 2012/0259771 A1
(43) Pub. Date: Oct. 11, 2012

(54) APPARATUS AND METHOD FOR PROVIDING A TRANSACTION SERVICE

(75) Inventors: Cheol-ju HWANG, Yongin-si (KR); Do-jun Yang, Yongin-si (KR)

(73) Assignee: Samsung Electronics Co., Ltd, Gyeonggi-do (KR)

(21) Appl. No.: 13/444,385

(22) Filed: Apr. 11, 2012

(30) Foreign Application Priority Data
Apr. 11, 2011 (KR) 10-2011-0033259

(51) Int. Cl. G06Q 20/22

(52) U.S. Cl. 705/39

(57) ABSTRACT

An apparatus and method for performing a transaction service, which includes receiving, by a service server, a transaction ID request for the transaction service with a service provider, from a user terminal, generating a transaction ID in response to the transaction ID request, providing the transaction ID to the user terminal, and receiving a transaction specification that corresponds to the transaction ID, from the service provider. The transaction specification is generated by the service provider using the transaction ID that is provided to the user terminal.

### PRIORITY

This application claims priority under 35 U.S.C. §119(a) to Korean Patent Application No. 10-2011-0033259, which was filed in the Korean Intellectual Property Office on Apr. 11, 2011, the entire disclosure of which is incorporated herein by reference.

### BACKGROUND OF THE INVENTION

1. Field of the Invention The present invention relates generally to financial transactions, and more particularly, to an apparatus and a method for providing a transaction service.

2. Description of the Related Art Generally, in online commerce or offline commerce, all payment methods, except for cash payment, require personal information, particularly, personal financial information, to pass from a payer to a payee. For example, when using a credit card offline, a payer presents the credit card to a payee, and thus personal financial information such as a card user name, a card number, a card expiration date, etc., passes to the payee. Although the personal financial information is passed, it is often done electronically, i.e., by swiping the credit card through a digital reader, and as such, the personal financial information is not as readily available to the payee. Most often, the payee only sees information indicating if the transaction is approved or denied by a financial institution.

However, in transactions in which a physical credit card is not presented by payer to a payee, e.g., telephone purchases or online commerce, a payer normally speaks or enters a card user name, a card number, a card expiration date, etc., rather than merely swiping a credit card. As such, the payee is provided with the personal financial information of the payer. It is this type of transaction that a user (or a payer) most often worries over the security of their personal financial information. Specifically, the personal information that has passed into the payee may be maliciously used by the payee or may leak outside due to attacks, e.g., Internet hacking, or mistakes caused buy the payee.

For example, during a credit card payment, a payer's credit card number, card expiration date, Card Verification Number (CVN), etc., may be exposed to the payee. Similarly, during mobile phone micropayment, a payer's phone number, resident registration number, etc., may be exposed to the payee. Further, when using a transfer account, a bank account number, password, etc., may be exposed, and even during a PayPal® transaction, the payer's e-mail address and the like may be exposed.

Additionally, the mere fact that a payer must provide the above-described information to the payee during payment, creates user inconvenience.

### SUMMARY OF THE INVENTION

The present invention has been made to address at least some of the above-identified problems and/or disadvantages and to provide at least the advantages described below.

Accordingly, an aspect of the present invention is to provide a service server, a user terminal, and a service providing method for performing a transaction service using a transaction Identification (ID).

In accordance with an aspect of the present invention, a method of performing a transaction service by a service server is provided. The method includes receiving, from a user terminal, a transaction Identification (ID) request for the transaction service between the user terminal and a service provider; generating a transaction ID in response to the transaction ID request; providing the transaction ID to the user terminal; and receiving, from the service provider, a transaction specification that corresponds to the transaction ID.

In accordance with another aspect of the present invention, a method of performing a transaction service by a user terminal is provided. The method includes transmitting, to a service server, a transaction Identification (ID) request for the transaction service with a service provider; receiving, from the service server, a transaction ID that is generated by the service server in response to the transaction ID request; and sending, to a settlement server, a request for settlement of a transaction specification that is generated by the service provider and corresponds to the transaction ID.

In accordance with another aspect of the present invention, a service server is provided for providing a transaction service. The service server includes a communication unit for receiving, from a user terminal, a transaction Identification (ID) request for the transaction service between the user terminal and a service provider; a transaction ID generation unit for generating a transaction ID in response to the transaction ID request; and a controller for controlling the communication unit to provide the transaction ID to the user terminal and to receive, from the service provider, a transaction specification that corresponds to the transaction ID.

In accordance with another aspect of the present invention, user terminal is provided for providing a transaction service. The user terminal includes a transaction Identification (ID) request unit for requesting, from a service server, a transaction ID for the transaction service with a service provider; a communication unit for receiving, from the service server, the transaction ID that is generated by the service server in response to the transaction ID request; and a controller for requesting, from a settlement server, settlement of a transaction specification that is generated by the service provider and corresponds to the transaction ID.

### BRIEF DESCRIPTION OF THE DRAWINGS

The above and other aspects, features, and advantages of the present invention will be more apparent from the following detailed description when taken in conjunction with the accompanying drawings, in which:

FIG. 1 illustrates a service system according to an embodiment of the present invention;

FIG. 2 is a block diagram illustrating a service server according to an embodiment of the present invention;

FIG. 3 is a block diagram illustrating a user terminal according to an embodiment of the present invention;

FIG. 4 is a flowchart illustrating a method of performing a transaction service by a service server according to an embodiment of the present invention;

FIG. 5 is a flowchart illustrating a method of performing a transaction service by a user terminal according to an embodiment of the present invention;

FIG. 6 is a signal flow diagram illustrating a method of providing a transaction service according to an embodiment of the present invention; and

FIG. 7 illustrates screen shot of a user terminal displaying a UI for providing a transaction service, according to an embodiment of the present invention.

### DETAILED DESCRIPTION OF EMBODIMENTS OF THE INVENTION

Hereinafter, various embodiments of the present invention are described in detail with reference to the accompanying drawings. The present invention may, however, be embodied in many different forms and should not be construed as limited to the embodiments set forth herein. Rather, these embodiments are provided so that this disclosure will be thorough and complete and will fully convey the scope of the invention to those skilled in the art.

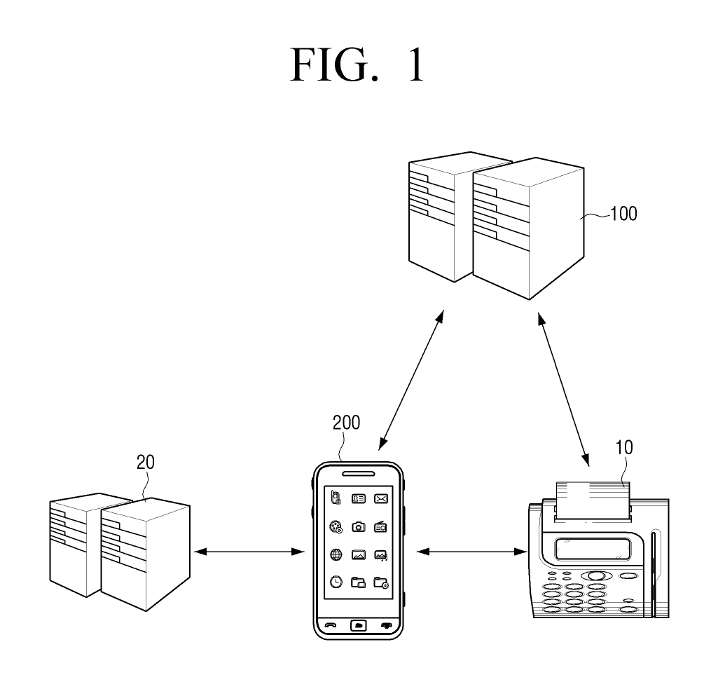

FIG. 1 illustrates a service system according to an embodiment of the present invention.

Referring to FIG. 1, a service system includes a service server 100, a user terminal 200, a service provider 10, and a settlement server 20.

The service server 100 provides a transaction service between a user and a service provider. For example, the service server 100 may be implemented by a cloud server that uses a cloud computing technology, i.e., Internet cloud computing technology. Cloud computing is a web cloud software service for calling and using a program that is put in a utility data server on the Internet at any time through a computer or a mobile phone. As the specific details of cloud computing are not essential to the description of the present invention, a more detailed description of cloud computing will be omitted.

The user terminal 200 accesses the service server 100 to receive a temporary transaction ID for a transaction with the service provider 20. For example, the user terminal 200 may be implemented by a wireless terminal, such as a mobile phone or a notebook computer, or a wired terminal such as a Personal Computer (PC) or kiosk. Accordingly, a user requests generation of a transaction ID for purchasing a good or service by accessing the service server 100 through the user terminal 200.

However, when the user terminal 200 can perform a network connection, determine its own location, and have an inherent address for connection, the user terminal 200 is not limited to the above-described example.

When a transaction ID request is received from the user terminal 200, the service server 100 generates and transmits a transaction ID to the user terminal 200. Accordingly, the user terminal 200 can then perform a transaction using the transaction ID, and thus, can prevent the passage of personal information to the service provider 10 during the transaction.

The service provider 10 may receive the transaction ID that is transmitted to the user terminal 200 and generate a transaction specification that corresponds to the transaction ID. In this case, the service provider 10, e.g., when the user terminal 200 is being used for online shopping, may receive the transaction ID that is input through an input window provided by a web browser of the user terminal 200. Further, when offline shopping, the service provider 10 may receive an input of the transaction ID from a user through a predetermined terminal or verbally.

The service provider 10 generates the transaction specification that corresponds to the transaction ID provided from the user and transmits the generated transaction specification to the service server 100. Here, the service provider 10 may be implemented by a Point Of Sale (POS) terminal or a mobile phone possessed by a provider that provides goods or services. For example, for an offline transaction, the service provider 10 may be implemented by a mobile terminal that is connected through a network, while for the online transaction, it may be implemented by a web hosting server.

Specifically, the service provider 10 generates the transaction specification using a predetermined application that is installed in the POS terminal or the mobile phone, and transmits the generated transaction specification to the service server 100 with the transaction ID that corresponds to the generated transaction specification.

In this case, the service server 100 may transmit the received transaction specification to the user terminal 200, or directly request settlement, i.e., payment, of the received transaction specification from a settlement server 20. However, when the service server 100 directly requests the settlement from the settlement server 20, the service server 100 first receives user settlement information such as a credit card, real-time transfer account, CMS transfer account, mobile phone SMS settlement, etc., from the user terminal

When the service server 100 or the user terminal 200 accesses the settlement server 20 with a predetermined transaction specification, the settlement server 20 processes a payment for settlement of the corresponding transaction specification. In this case, the settlement server 20 may perform the settlement in diverse ways, such as a credit card, real-time transfer account, CMS transfer account, mobile phone SMS settlement, etc., with respect to the transaction specification. Accordingly, the settlement server 20 may be implemented by diverse servers that can provide a settlement service, such as a credit card company server, a bank server, a communication company server, a PayPal® service provider server, etc., as a Payment Service Provider (PSP).

For example, when the settlement server 20 performs a credit card settlement, the settlement server 20 transmits information on a transaction through a Payment Gate (P/G) company that provides an e-commerce payment solution. The P/G company notifies a Value Added Network (VAN) company of the transaction details, and the VAN company requests transaction approval from a credit card company. Thereafter, the settlement server 20 pays the settlement amount to a merchandiser, and the credit card company sends a transaction statement to the user (i.e., purchaser) to repay the purchase amount.

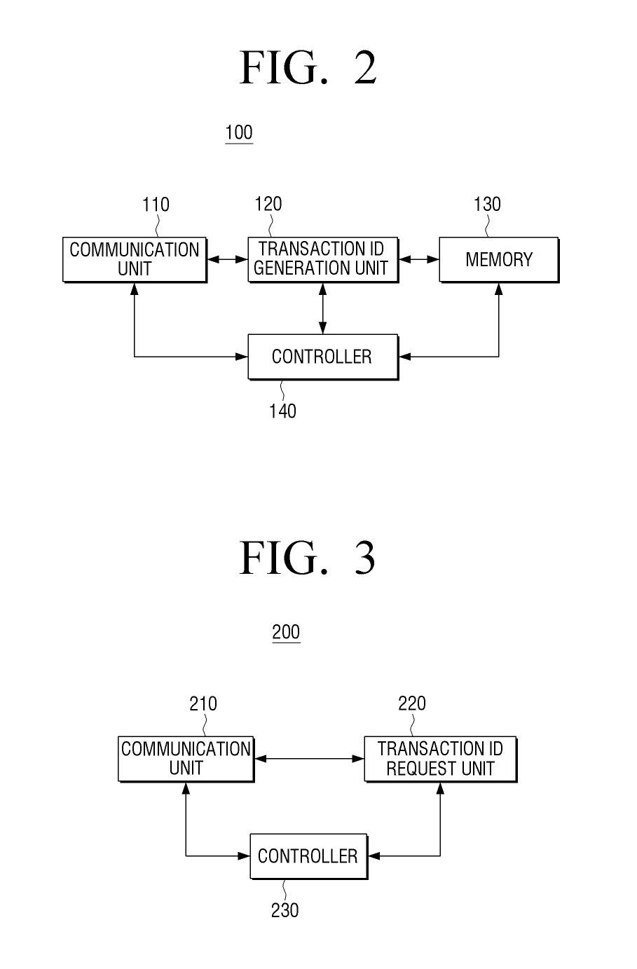

FIG. 2 is a block diagram illustrating a service server according to an embodiment of the invention.

Referring to FIG. 2, the service server 100 includes a communication unit 110, a transaction ID generation unit 120, a memory 130, and a controller 140.

The communication unit 110 receives a transaction ID request for a service transaction with the service provider 10 from the user terminal 200. Here, the communication unit 110 may perform communication according to diverse communication systems such as a Short Message Service/Multimedia Message Service (SMS/MMS) and an Internet Protocol (IP) network. The transaction ID request may include a transaction ID request time and at least one of a user terminal position and a user terminal number.

The transaction ID generation unit 120 generates the transaction ID according to the transaction ID request received through the communication unit 110. The transaction ID may be a temporary transaction ID that is used for the corresponding transaction only. For example, the transaction ID may be in the form of a hash function, but is not limited thereto.

The memory 130 stores a transaction ID request time, at least one of the user terminal position and the user terminal number, and a transaction ID, which are included in the transaction ID request. The stored information may be used for transaction specification transmission or the like.

The controller 140 controls the entire operation of the service server 100. In particular, the controller 140 controls the communication unit 110 to provide the transaction ID that is generated by the transaction ID generation unit 120 to the user terminal 200 that has requested the transaction ID generation.

The transaction ID provided to the user terminal 200 may be provided to the service provider 10 in diverse ways.

For example, for online shopping, the service provider 10 may receive a transaction ID, which is input through an input window of a web browser. For offline shopping, the service provider 10 may receive an input of a transaction ID from a user through a predetermined terminal, e.g., sales kiosk, or verbally.

The service provider 10 receives the transaction ID and generates a transaction specification that corresponds to the transaction ID. In this case, the service provider 10 generates a corresponding transaction specification based on the received transaction ID, and transmits the transaction specification to the service server 100.

Specifically, the service provider 10 generates a transaction specification using a predetermined application that is installed in a POS terminal or a mobile phone, and transmits the generated transaction specification to the service server 100 with the corresponding transaction ID. As described above, the service provider 10 may be implemented by a POS terminal or a mobile phone possessed by a provider that provides goods or services.

The control unit 140 controls the communication unit 110 to receive the transaction specification that corresponds to the transaction ID from the service provider 10. Additionally, the control unit 140 may control the communication unit 110 to receive the transaction specification transmission time, the transaction ID, and at least one of the service provider position and the service provider identification number in addition to the transaction specification. In this case, the identification number may be a terminal address such as a mobile phone number, an IP address, or a Uniform Resource Locator (URL).

Further, the control unit 140 controls the communication unit 110 to transmit the received transaction specification to the corresponding user terminal 200. Specifically, the control unit 140 controls the communication unit 110 to transmit the transaction specification to the user terminal 200 based on the transaction ID that is stored in the memory 130 and the user terminal number that has transmitted the corresponding transaction ID.

Further, the control unit 140 requests the settlement of the transaction specification by accessing the settlement server 20.

The control unit 140 controls the communication unit 110 to transmit a confirmation message for confirming the validity of the transaction to the user terminal 200, if a difference between the transaction ID request time from the user terminal 200 and the transaction specification transmission time from the service provider 10 is longer than or equal to a preset time.

The transaction ID generation unit 120 may generate a transaction ID that has a different form according to the distance between the user terminal 200 and the service provider 10, based on the user terminal position that is received from the user terminal 200 and the service provider position that is received from the service provider 10. Specifically, if the distance between the user terminal 200 and the service provider 10 is shorter than a predetermined distance, the transaction ID generation unit 120 generates a short-length transaction ID, e.g., a transaction ID composed of a three or four-digit number in consideration of input convenience, and if the distance is longer than or equal to the predetermined distance, the transaction ID generation unit 120 generates a long-length transaction ID, e.g., a transaction ID that includes an eight or nine-digit number or English characters to avoid overlapping of transaction IDs.

Further, if the distance between the user terminal 200 and the service provider 10 is longer than or equal the predetermined distance, the transaction ID generation unit 120 may receive identification information, for example, a flag that indicates a long distance, instead of the position of the user terminal 200 and the position of the service provider 10.

Although FIG. 2 illustrates a transaction ID generation unit 120 and a controller 140 as separate components of the service server 100, the transaction ID generation unit 120 and controller 140 could also be embodied as a single component.

FIG. 3 is a block diagram illustrating a user terminal according to an embodiment of the present invention.

Referring to FIG. 3, a user terminal 200 includes a communication unit 210, a transaction ID request unit 220, and a controller 230.

The transaction ID request unit 220 generates and transmits a transaction ID request for a service transaction with the service provider 10 to the service server 100. The transaction ID request may include a transaction ID request time and at least one of a user terminal position and a user terminal number.

The position of the user terminal device 200 may be calculated through a built-in Global Positioning System (GPS) module (not shown). Specifically, the user terminal 200 may receive a GPS signal from a GPS satellite, generate position information, and transmit the generated position information to the service server 100.

The communication unit 210 communicates with the service server 100, and receives a transaction ID from the service server 100, in response to the transaction ID request. For example, the communication unit 210 may communicate according to diverse communication systems such as SMS/MMS and IP network.

Further, the communication unit 210 may transmit a transaction ID that is received from the service server 100 to the service provider 10, and receive the transaction specification that is generated by the service provider. In this case, the service provider 10 generates the transaction specification that corresponds to the transaction ID received from the user terminal 200 and transmits the generated transaction specification to the service server 100. The service server 100 provides the transaction specification that is transmitted from the service provider 10 to the user terminal 200.

When the transaction specification that corresponds to the transaction ID transmitted from the service server 100 is received, the controller 230 requests settlement of the transaction specification by accessing the external settlement server 20. As described above, the settlement may be made in diverse ways, such as a credit card, real-time transfer account, CMS transfer account, mobile phone SMS settlement, etc., with respect to the transaction specification.

Although FIG. 3 illustrates a transaction ID request unit 220 and a controller 230 as separate components of the service server 100, the transaction ID request unit 220 and controller 230 could also be embodied as a single component.

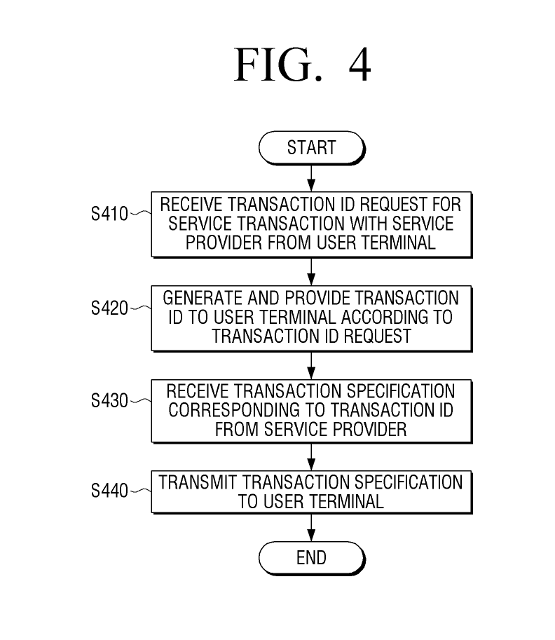

FIG. 4 is a flowchart illustrating a method of performing a transaction service by a service server according to an embodiment of the invention.

Referring to FIG. 4, the service server receives a transaction ID request for a transaction service with a service provider from a user terminal in step S410. In step S420, the service server generates a transaction ID according to the transaction ID request, and provides the generated transaction ID to the user terminal. For example, the transaction ID is an ID that is temporarily used for the corresponding transaction, and may be implemented by a hash function. Additionally, the transaction ID that is received by the user terminal 200 may be provided to the service provider 10 online or offline, as described above, such that the service provider may generate a transaction specification that corresponds to the provided transaction ID.

In step S430, the service server receives the transaction specification that corresponds to the transaction ID from the service provider.

In step S440, the service server transmits the transaction specification to the user terminal.

Although not illustrated in FIG. 4, the service server may directly request settlement from the settlement server using the transaction specification. In this case, the service server transmits an inquiry message to the user terminal, inquiring whether to proceed with the settlement, and if a confirmation message is received, it proceeds with the settlement. The service server may then transmit a message for the result of the settlement to the user terminal.

Additionally, although not illustrated in FIG. 4, the service server may store a transaction ID, a transaction ID request time, and at least one of a user terminal position and a user terminal number, which are included in the transaction ID request. Accordingly, the service server may then transmit the transaction specification to the user terminal, based on the stored information.

Further, the service server may also receive a transaction ID, a transaction specification transmission time, and at least one of a service provider position and a service provider identification number, in addition to the transaction specification in step S430.

Further, the service server may transmit a confirmation message for confirming the validity of the transaction to the user terminal, if a difference between the transaction ID request time from the user terminal and the transaction specification transmission time from the service provider is longer than or equal to a preset time.

As described above, the service server may generate a transaction ID that has a different form according to the distance between the user terminal and the service provider.

Further, if the distance between the user terminal and the service provider is longer than or equal to a predetermined distance, the service server may receive predetermined identification information instead of a position of the user terminal and a position of the service provider.

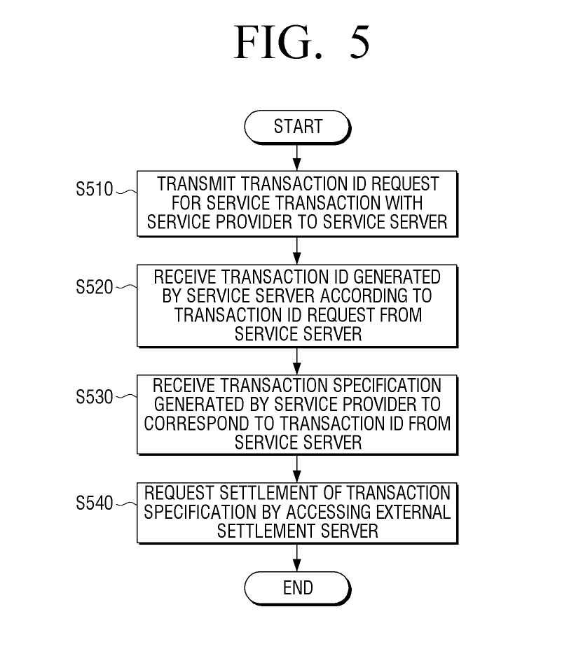

FIG. 5 is a flowchart illustrating a method of providing a transaction service by a user terminal according to an embodiment of the present invention.

Referring to FIG. 5, the user terminal transmits a transaction ID request for a transaction service with a service provider to a service server in step S510. The transaction ID request may include a transaction ID request time and at least one of a user terminal position and a user terminal number.

In step S520, the user terminal receives a transaction ID that is generated in response to the transaction ID request from the service server 100. Additionally, the service provider generates a transaction specification that corresponds to the received transaction ID.

In step S530, the user terminal receives the transaction specification from the service server. For example, the service server may transmit the transaction specification to the corresponding user terminal based on pre-stored information.

In step S540, the user terminal requests the settlement of the transaction specification by accessing a settlement server.

According to another embodiment of the present invention, the service server that has received the transaction specification, which is transmitted to the user terminal in step S530, may directly request the settlement from the settlement server, and in this case, the user terminal receives only an inquiry message inquiring whether to perform settlement and/or a message indicating a result of the settlement.

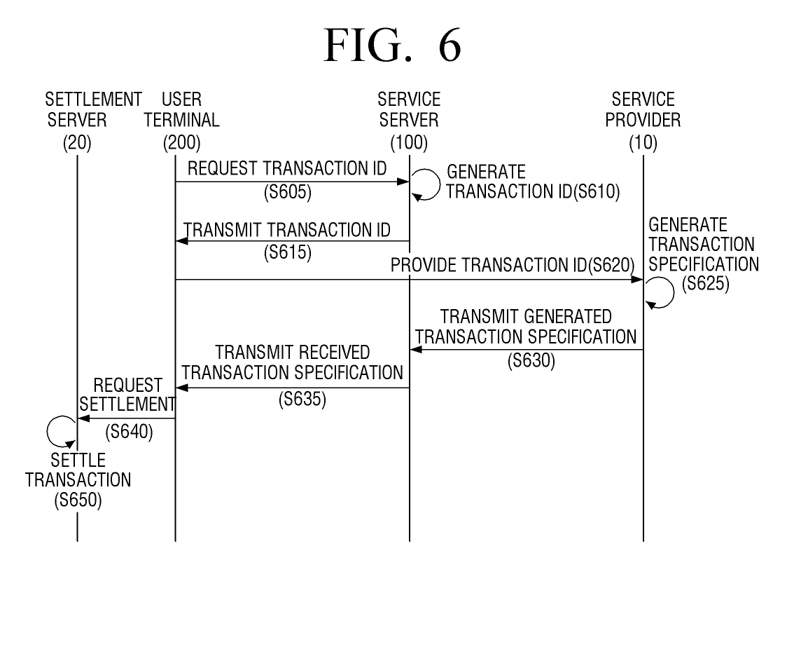

FIG. 6 is a signal flow diagram illustrating a method of providing a transaction service according to an embodiment of the present invention.

Referring to FIG. 6, a user of user terminal 200 who intends to perform a transaction service, e.g., purchase goods or services, with a service provider 10, requests a transaction ID from a service server 100 in step S605.

The service server 100, generates the transaction ID in step S610, and transmits the generated transaction ID to the user terminal 200 in step S615.

In step 620, the user of user terminal 200 provides the transaction ID to the service provider 10. Here, the transaction ID that is received by the user terminal 200 may be provided to the service provider 10 online or offline, as described above.

The service provider 10 generates a transaction specification that corresponds to the transaction ID in step S625, and transmits the generated transaction specification to the service server 100 in step S630.

In step S635, the service server 100 transmits the received transaction specification to the user terminal 200.

In step S640, the user terminal 200 requests the settlement of the transaction specification from a settlement server 20.

In step S650, assuming the settlement server 20 approves the transaction, the settlement server 20 settles the transaction with the service provider 10.

Alternatively, although not illustrated in FIG. 6, after receiving the generated transaction specification in step S630, the service server 100, may directly request the settlement of the transaction specification from the settlement server 20, omitting steps S635 and S640. In this case, the user terminal 200 may receive an inquiry message inquiring whether to perform settlement and/or a message indicating a result of the settlement.

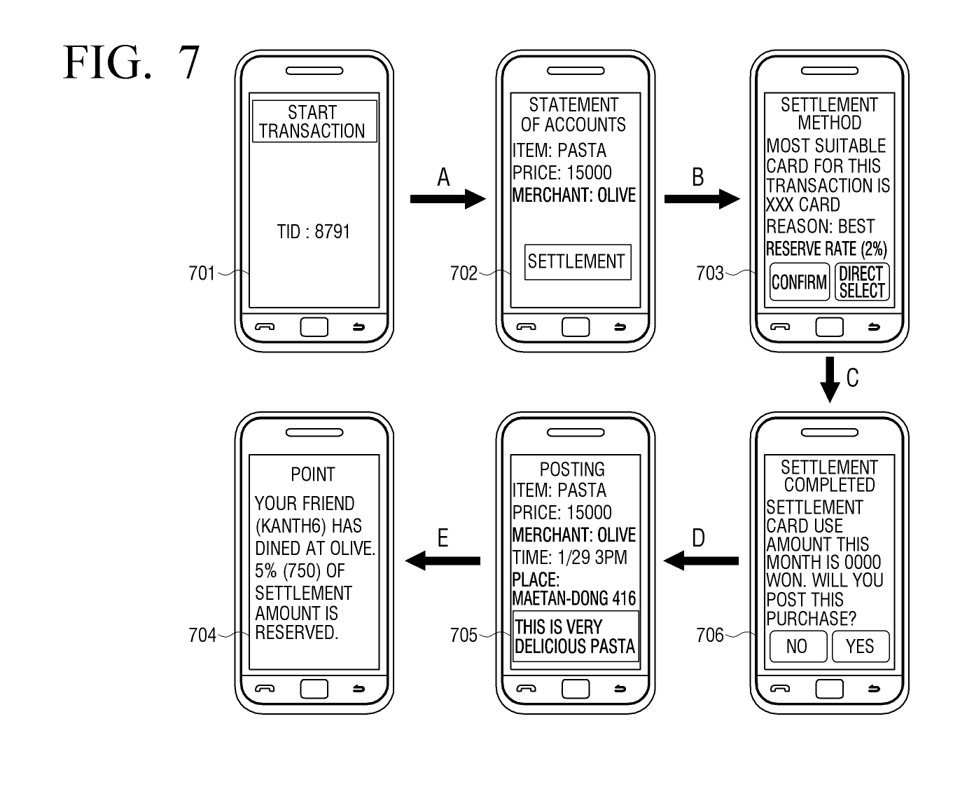

FIG. 7 illustrates screen shot of a user terminal displaying a UI for providing a transaction service, according to an embodiment of the present invention.

Referring to FIG. 7, when a transaction starts, the user terminal receives a Transaction ID (TID) for the transaction from a service server, as shown in screen 701. For example, the user terminal may receive the transaction ID “8791”.

The transaction ID that is provided to the user terminal is then provided to the service provider. For an online transaction, the transaction ID may be provided to the service provider in an input window that is displayed on the user terminal. For an offline transaction, the transaction ID may be verbally provided to the service provider, e.g., spoken to a sales clerk.

A transaction specification that corresponds to the transaction ID, i.e., a transaction statement, is provided to the user terminal, as shown in screen 702. If the user selects the settlement of the transaction statement that is provided to the user terminal, an optimum settlement method for the corresponding transaction statement may be recommended, as shown in screen 703. In this case, in recommending the optimum settlement method, a discount rate, a point reserve rate, a type of payment in installments (whether interest-free installment is possible), benefits of cash settlement, etc., may be considered.

Further, when the recommended optimum settlement method is not selected, a selection menu for directly selecting the settlement method (“direct selection”) may be displayed.

When the settlement method is selected, an inquiry window for inquiring whether to post the corresponding purchase may be displayed together with a settlement completion message, as shown in screen 704.

If the posting of the corresponding purchase is selected, the corresponding purchase information can be posted, e.g., on a social networking site, as shown in screen 705.

In this case, when another user performs the transaction with the corresponding service provider by the corresponding posting, the user who presents the posting may receive the corresponding benefits, as shown in screen 706. For example, a predetermined rate of the amount settled by the other user may be reserved as a point for the user who presents the posting.

The service server, the transaction service providing method, the user terminal, and the UI providing method, as described above, may be applied and used in the e-commerce field.

Accordingly, because the information that the user (or the user terminal device) provides to the service provider is only a temporary transaction ID, which does not include the user's personal financial information, the possibility of the user's personal financial information being compromised is reduced.

Further, because the information that the user should input during the transaction is only the transaction ID, the user can easily perform the transaction.

Accordingly, the above-described embodiments of the present invention provide a safe and convenient payment method, without exposing a user's personal information to a merchant or service provider.

While the present invention has been shown and described with reference to certain embodiments thereof, it will be understood by those skilled in the art that various changes in form and detail may be made therein without departing from the spirit and scope of the present invention, as defined by the appended claims and their equivalents.

What is claimed is:

1. A method of performing a transaction service by a service server, the method comprising the steps of:
receiving, from a user terminal, a transaction Identification (ID) request for the transaction service between the user terminal and a service provider;
generating a transaction ID in response to the transaction ID request;
providing the transaction ID to the user terminal; and
receiving, from the service provider, a transaction specification that corresponds to the transaction ID.

2. The method of claim 1, further comprising transmitting the transaction specification to the user terminal.

3. The method of claim 1, further comprising requesting settlement of the transaction specification from a settlement server.

4. The method of claim 1, wherein the transaction ID request includes at least one of a transaction ID request time, a user terminal position, and a user terminal number.

5. The method of claim 4, further comprising storing the transaction ID, and the at least one of the transaction ID request time, the user terminal position, and the user terminal number;
wherein the transaction specification is transmitted to the user terminal using the stored transaction ID, and the at least one of the transaction ID request time, the user terminal position, and the user terminal number.

6. The method of claim 1, wherein the transaction specification includes at least one of a transaction specification transmission time, the transaction ID, a service provider position, and a service provider identification number.

7. The method of claim 1, wherein the transaction ID varies based on a distance between the user terminal and the service provider.

8. The method of claim 1, wherein when a distance between the user terminal and the service provider is at least equal to a predetermined distance, the transaction ID is generated using predetermined identification information, instead of a user terminal position and a service provider position.

9. A method of performing a transaction service by a user terminal, the method comprising the steps of:
transmitting, to a service server, a transaction Identification (ID) request for the transaction service with a service provider;
receiving, from the service server, a transaction ID that is generated by the service server in response to the transaction ID request; and
sending, to a settlement server, a request for settlement of a transaction specification that is generated by the service provider and corresponds to the transaction ID.

10. The method of claim 9, wherein the transaction ID request includes at least one of a transaction ID request time, a user terminal position, and a user terminal number.

11. A service server for providing a transaction service, comprising:
a communication unit for receiving, from a user terminal, a transaction Identification (ID) request for the transaction service between the user terminal and a service provider;
a transaction ID generation unit for generating a transaction ID in response to the transaction ID request; and
a controller for controlling the communication unit to provide the transaction ID to the user terminal and to receive, from the service provider, a transaction specification that corresponds to the transaction ID.

12. The service server of claim 11, wherein the controller controls the communication unit to transmit the transaction specification to the user terminal.

13. The service server of claim 11, wherein the controller controls the communication unit to transmit, to a settlement server, a request for settlement of the transaction specification.

14. The service server of claim 11, wherein the transaction ID request comprises at least one of:
a transaction ID request time;
a user terminal position; and
a user terminal number.

15. The service server of claim 14, further comprising a memory for the at least one of storing the transaction ID, the transaction ID request time, the user terminal position, and the user terminal number,
wherein the controller controls the communication unit to transmit the transaction specification to the user terminal using the stored at least one of the transaction ID, the transaction ID request time, the user terminal position, and the user terminal number.

16. The service server of claim 11, wherein the controller controls the communication unit to receive at least one of a transaction specification transmission time, the transaction ID, a service provider position, and a service provider identification number from the service provider.

17. The service server of claim 11, wherein the transaction ID varies according to a distance between the user terminal and the service provider.

18. The service server of claim 11, wherein when a distance between the user terminal and the service provider is at least equal to a predetermined distance, the transaction ID generation unit generates the transaction ID using predetermined identification information, instead of a user terminal position and a service provider position.

19. A user terminal for providing a transaction service, comprising:
a transaction Identification (ID) request unit for requesting, from a service server, a transaction ID for the transaction service with a service provider;
a communication unit for receiving, from the service server, the transaction ID that is generated by the service server in response to the transaction ID request; and
a controller for requesting, from a settlement server, settlement of a transaction specification that is generated by the service provider and corresponds to the transaction ID.

20. The user terminal of claim 19, wherein the transaction ID request comprises at least one of:
a transaction ID request time;
a user terminal position; and
a user terminal number.
